(19) United States
(12) Patent Application Publication
(10) Pub. No.: US 2008/0194320 A1
(43) Pub. Date: Aug. 14, 2008

(54) Three-Dimensional Gaming System Environments

(76) Inventors: John Walsh, Gurnee, IL (US); Larry Pacey, Chicago, IL (US); Jeremy Hornik, Chicago, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 12/063,643

(22) PCT Filed: Aug. 3, 2006
(86) PCT No.: PCT/US06/30191

§ 371 Date: Feb. 12, 2008

Related U.S. Application Data
(60) Provisional application No. 60/707,707, filed on Aug. 12, 2005.

(51) Int. Cl. A63F 13/00

(52) U.S. Cl. 463/25; 463/32; 463/43

(57) ABSTRACT

Methods and apparatus affecting the interaction between events, objects, and three-dimensional wagering game environment are described herein.

### RELATED APPLICATIONS

This application claims the priority benefit of U.S. Provisional Application Ser. No. 60/707,707, filed Aug. 12, 2005, the contents of which are incorporated herein by reference.

This disclosure is related to pending U.S. Provisional Patent Application Ser. No. 60/707,610, titled “Characters in Three-Dimensional Gaming System Environments”, filed on Aug. 12, 2005, owned by WMS Gaming Inc., and incorporated herein by reference in its entirety.

### TECHNICAL FIELD

The material disclosed by this document relates generally to the field of wagering game systems, including apparatus, systems, and methods for the modification and display of three-dimensional environments in a wagering game machine.

### COPYRIGHTS

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### BACKGROUND INFORMATION

Wagering game makers labor continually to provide new and entertaining games. For example, pick games and reel-based games are popular. In a pick game, the player chooses from a number of selections. The selection then triggers particular gaming outcomes. In reel-based games, mechanical or simulated slot reels can be rotated and stopped to place symbols on the reels in visual association with one or more pay lines. If the selected outcome is one of the winning outcomes defined by a pay table, the processor may award the player with a number of credits associated with the winning outcome.

One conventional way of increasing the entertainment value associated with casino-style wagering games (e.g., slots, poker, blackjack, roulette, bingo, keno, and the like) includes offering a base game and a variety of bonus events. Thus, pick games may be used alone, or in combination with reel-based games to provide bonus events. Bonus events may occur outside the reel spin, for example, injecting a random event, or perhaps fostering player interaction to trigger a random event.

Whatever type of game is involved, players tend to become disinterested in repetitive base games and bonus events. Thus, in order to maintain player interest, there is a need for wagering game machine makers to update game themes, game settings, and bonus events, as well as opportunities for player-game interaction.

### BRIEF DESCRIPTION OF THE DRAWINGS

FIG. 1 illustrates a gaming machine apparatus according to various embodiments of the present invention.

FIG. 2 illustrates apparatus and systems, including an article of manufacture, according to various embodiments of the invention.

FIG. 3 is a block diagram of an exemplary wagering game network according to various embodiments of the invention.

FIG. 4 illustrates a three-dimensional environment in a gaming machine according to various embodiments of the invention.

FIGS. 5A-5B include a flow diagram illustrating several methods according to various embodiments of the invention.

### DETAILED DESCRIPTION

In some embodiments of the invention, the challenges described above may be addressed by implementing apparatus, systems, and methods that affect the interaction between characters, events, such as gaming outcomes, and three-dimensional visual environments in a wagering game.

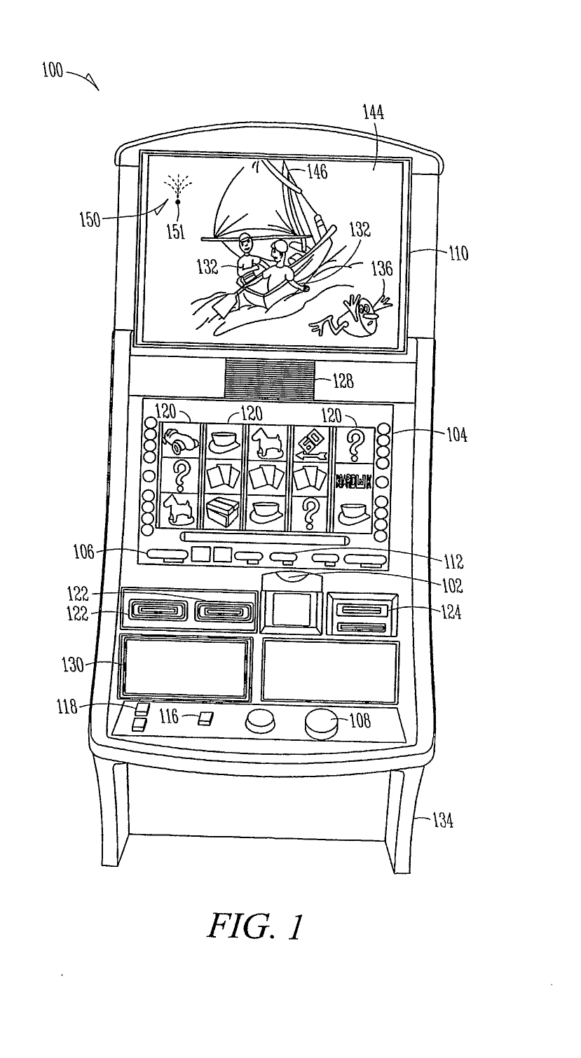

FIG. 1 illustrates a gaming machine 100 apparatus according to various embodiments of the present invention. As shown in FIG. 1, the gaming machine 100 may include a computerized slot machine having the controls, displays, and features of a conventional slot machine, if desired.

The gaming machine 100 can be operated while players are standing or seated. Additionally, the gaming machine 100 may be mounted on a stand (not shown). The gaming machine 100 may also be constructed as a pub-style tabletop game (not shown), which a player can operate while sitting. Furthermore, the gaming machine 100 can be constructed with varying enclosure (e.g. a floor-standing cabinet or a hand-held unit) and display designs. The gaming machine 100 can incorporate any primary game such as slots, poker, black-jack, bingo, roulette, or keno, and additional bonus round games. The symbols and indicia used on and in the gaming machine 100 can take mechanical, electrical, or video form.

As illustrated in FIG. 1, the gaming machine 100 may comprise a wagering gaming machine, perhaps including a coin slot 102 and/or bill acceptor 124. Players can place coins in the coin slot 102 and paper money or ticket vouchers in the bill acceptor 124. Other devices can be used for accepting payment. For example, credit/debit card readers/validators 122 can be used for accepting payment. Additionally, the gaming machine 100 can perform electronic funds transfer operations and financial transfers to procure monies from financial accounts.

In any case, when funds become available, such as after a player inserts money in the gaming machine 100, the number of credits corresponding to the amount deposited are shown in a credit display 106. After providing the appropriate amount of money, a player can begin playing the game by operating a player-input device 108, which may comprise a joystick, a play button, a touch screen, a trackball, a capacitive switch, a microphone, a camera, or any other device capable of being used to start a wagering game, or influence the sequence of events in a wagering game conducted by the gaming machine 100.

As shown in FIG. 1, the gaming machine 100 also includes a bet display 112 and a “bet one” button 116. The player may place a bet by pushing the bet one button 116. The player can also increase the bet by one credit each time the player pushes the bet one button 116. When the player pushes the bet one button 116, the number of credits shown in the credit display 106 may decrease by one credit, while the number of credits shown in the bet display 112 may increase by one credit. Other incremental amounts of credit may be attributed to the credit display 106 and the bet display 112 by activating the bet one button, if desired.

A player may end the course of play or “cash out” by pressing a cash out button 118. When a player cashes out, the gaming machine 100 may dispense a voucher or currency corresponding to the number of remaining credits. The gaming machine 100 may employ other payout mechanisms, such as credit slips (which are redeemable by a cashier), electronically recordable cards (which track player credits), and electronic funds transfer, among others.

The gaming machine 100 may include a primary display unit 104, and perhaps a secondary display unit 110 (also known as a “top box”). The gaming machine 100 may also include an auxiliary video display 130. In one embodiment, the primary display unit 104 is used to display a plurality of video reels 120. According to some embodiments of the invention, the display units 104 and 110 can include any visual representation or exhibition, including moving physical objects (e.g., mechanical reels and wheels), dynamic lighting, and video images, including characters 132 and three-dimensional environments 144. In some embodiments, each reel 120 includes a plurality of symbols such as bells, hearts, fruits, numbers, letters, bars or other images, including characters, which correspond to a theme associated with the gaming machine 100. Furthermore, as shown in FIG. 1, the gaming machine 100 may include an audio presentation unit 128. The audio presentation unit 128 can include audio speakers or other suitable sound projection devices.

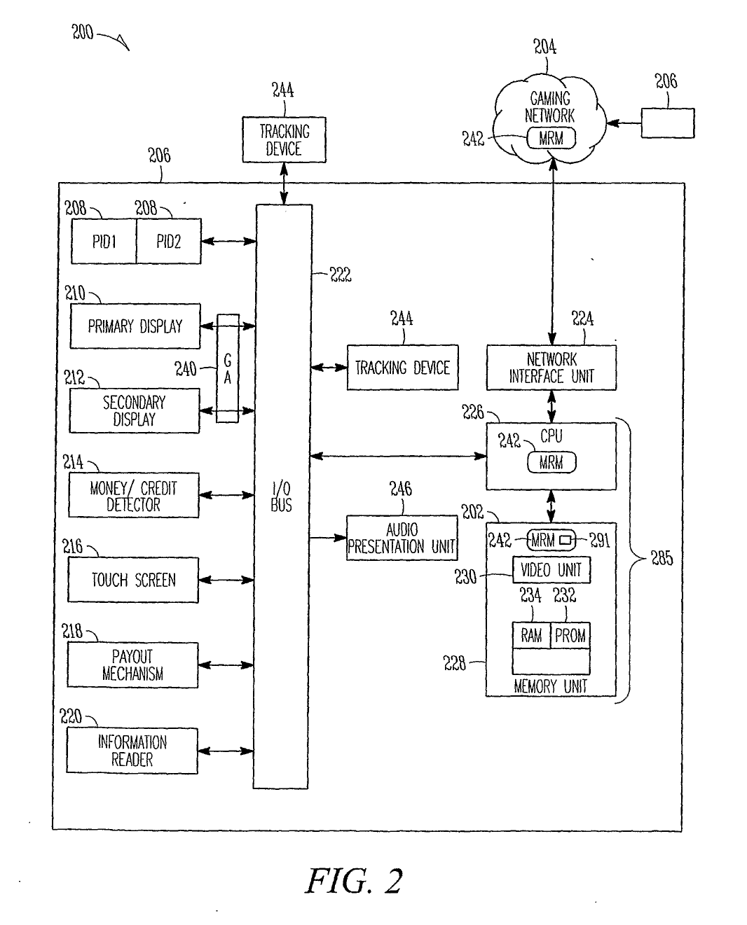

FIG. 2 illustrates apparatus and systems, including a gaming machine 206 and an article of manufacture 202, according to various embodiments of the invention. The gaming machine 206 may be similar to, or identical to the gaming machine 100 (see FIG. 1), discussed previously, and may be included in a wagering game system 200.

As shown in FIG. 2, the gaming machine 206 may include one or more central processing units (CPUs) 226 connected to a memory unit 228, which can include a volatile memory 234 (e.g., random access memory (RAM)) and a nonvolatile memory 232 (e.g., programmable read only memory (PROM)). The CPU 226 may also be connected to a network interface unit 224 (e.g., wired or wireless) that, in turn, may be coupled to a gaming network 204, such as a serverless gaming network.

The CPU 226 may also be connected to an input/output (I/O) bus 222. The I/O bus 222 can be connected to one or more player-input devices 208, one or more displays, such as a primary display 210 and a secondary display 212, a money/credit detector 214, a touch screen 216, a payout mechanism 218, and an information reader 220, and an audio presentation unit 246 (similar to or identical to the audio presentation unit 128 of FIG. 1). A graphics accelerator 240 may be coupled between the I/O bus 222 and the displays 210, 212. In this way, the I/O bus 222 can be used to facilitate communication between the system components and the CPU 226.

Thus, according to some embodiments, the gaming machine 206 can include additional peripheral devices and/or more than one of the components shown in FIG. 2. For example, in one embodiment, the gaming machine 206 may include multiple network interface units 224 and multiple CPUs 226. Additionally, the components of the gaming machine 206 can be interconnected according to any suitable interconnection architecture (e.g., directly connected, hypercube, etc.).

According to some embodiments, any element of the the gaming machine 206 may include machine-readable media 242 with instructions stored thereon for conducting a basic wagering game, conducting a bonus game, and storing and/or transmitting non-monetary player information in a gaming network 204. Machine-readable media 242 includes any mechanism that provides (i.e., stores and/or transmits) information in a form readable by a machine (e.g., a computer or processor). For example, a machine-readable medium 242 may include ROM, PROM, RAM, magnetic disk storage media, optical storage media, flash memory devices, electrical, optical, acoustical, or other forms of propagated signals (e.g., carrier waves, infrared signals, digital signals, etc.). According to some embodiments of the invention, the gaming machine 206 and other components of the gaming network 204 can include other types of logic (e.g., digital hardware logic and/or firmware) for executing the operations described herein.

The gaming machine 206 can present any type of pick game or casino style wagering game, such as poker, black jack, slots, bingo, roulette, keno, etc. In one embodiment, the wagering games can include a base game and a bonus game. When executing the base game, the gaming machine 206 can present a plurality of symbols that indicate a randomly selected outcome, which is selected from a plurality of outcomes. For example, when presenting a video slots game to a player, the gaming machine 206 can present a set of reel symbols that indicates the game's outcome. Based on the outcome, the gaming machine 206 can provide monetary awards and non-monetary assets for acquisition by the player, or a proxy for the player (e.g., a magnetic card, or a second player designated by the first player).

Non-monetary assets can represent any feature or element of a base game or an associated bonus game. When the base and bonus games are presented in conjunction with a theme, the non-monetary assets can represent objects related to the theme. For example, for base and bonus games based on the Hasbro Inc. Monopoly® board game, non-monetary assets can represent elements of the board game, such as properties shown on the game board, houses, hotels, Chance cards, Community Chest cards, etc. As another example, for base and bonus games based on the Hollywood Squares™ television show, non-monetary assets can represent Xs or Os on a tic-tac-toe board.

According to some embodiments, non-monetary assets can be used for initializing and conducting base and bonus games. For example, after a player accumulates a certain combination of non-monetary assets (referred to herein as an awarded set of non-monetary assets), the gaming machine 206 can present a bonus game based on the non-monetary assets. For example, the gaming machine 206 can initialize, conduct, and display a three-dimensional Monopoly® bonus game environment based on properties and houses a player “owns” (i.e., the player's non-monetary assets). In one embodiment, the non-monetary information set used for initializing the bonus game is referred to as a “bonus-starting” set.

In addition to awarding and tracking non-monetary assets, the gaming machine 206 can track and modify other non-monetary information, such as player tracking information, casino preferences, and player preferences. Non-monetary information can also include any other information relating to a base game or bonus game.

According to some embodiments, player tracking information can include information about a player's playing habits. For example, the player tracking information can include dates and times games were played, money wagered, wagering patterns, money won, money lost, gaming machines used, and other player information. This information, obtained via direct solicitation (e.g., querying the player) or indirect solicitation (e.g., when a gaming machine 206 accesses local storage, a magnetic card or radio-frequency identification device carried by the player, or storage on a network coupled to the gaming machine 206), may be used to select an initial character for use in the three-dimensional environment, as well as various features of the character. Initial environments and features of environments may be selected in a similar fashion.

Casino preferences can include information for configuring certain aspects of a game. Casino preferences can include information about maximum wagers, minimum wagers, bet one increments, game duration, maximum losses allowed for a player, and other casino related information.

Player preferences can include information used for configuring certain aspects of a game. For example, player preferences can include background music, game color scheme, volume, bonus game preferences, etc.

The gaming machine 206 can track players and their non-monetary player information (including non-monetary assets) using tickets, vouchers, electronic cards, etc. In one embodiment, the gaming machine 206 stores in a local persistent storage device (e.g., the gaming device's non-volatile PROM) a set of non-monetary player information accumulated during a player gaming session. The gaming machine 206 also stores a unique identifier associated with the player and the set of non-monetary player information. According to some embodiments, when a player terminates a gaming session, the gaming device 206 prints a voucher bearing the unique identifier. If the player uses the ticket to initiate another gaming session on a node (e.g., any gaming machine 206) on the gaming network 204, the node can request and receive from the original gaming machine 206 the set of non-monetary player information associated with the unique identifier stored in the PROM. Of course, such information may be previously uploaded and stored in a medium 242 located in the network 204. As a result, the player may have access to accumulated non-monetary player information including non-monetary assets from a number of nodes (e.g., any gaming machine 206) on the gaming network 204, which may comprise a global computer network, including the Internet. Such cumulative information may include characters, environments, features thereof, and other information particular to an identified player, or simply a unique identifier. Awards and bonuses may be responsive to the cumulative information, and vice versa.

In addition to using tickets for tracking non-monetary player information, embodiments of the gaming machine 206 can also use biometric devices, smart cards, magnetic cards, radio frequency identification (RFID) tags, and/or any other suitable player-tracking device 244. For embodiments that use player-tracking devices 244, the unique identifier associated with the player's non-monetary player information may be stored in the player-tracking device 244. If the player presents the player tracking device 244 bearing the unique identifier, perhaps inserting it into a slot in the gaming machine 206 so as to couple the player-tracking device 244 to the I/O bus 222, the gaming network 204 may provide the non-monetary player tracking information associated with the unique identifier to any node on the network 204 (e.g., any gaming machine 206 coupled to the network 204).

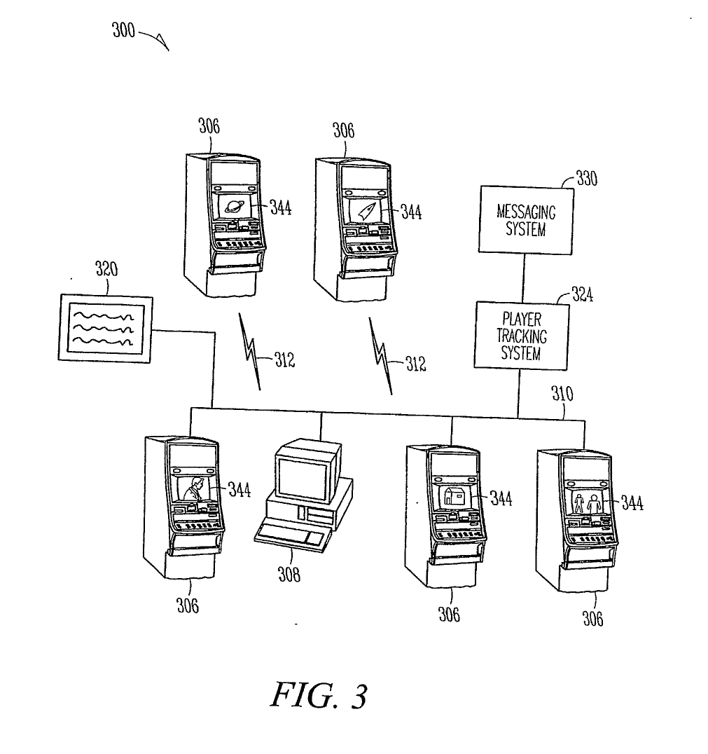

FIG. 3 is a block diagram of an exemplary wagering game network 300, according to various embodiments of the invention. The wagering game network 300 may be similar to or identical to the gaming network 204, and may include a plurality of wagering game machines 306 (similar to or identical to the wagering game machine 206 in FIG. 2), as well as one or more cluster controllers 308. These components of the wagering game network 300 can communicate over wired connections 310 and/or wireless connections 312. The wagering game machines 306 can be coupled to the wagering game network 300 using any suitable wired or wireless connection technology, such as Bluetooth, 802.11x, Ethernet, etc.

Cluster controllers 308 can be used for monitoring the operation of the wagering game machines 306 and/or controlling game machine related systems, such as wide-area progressive games, player tracking systems, and casino messaging systems. Thus, in some embodiments, the wagering game machines 306 can be part of a wide-area progressive game.

For example, in certain embodiments, the cluster controller 308 can accumulate and distribute progressive jackpots, while the wagering game machines 306 can determine whether players have won the progressive jackpots. Because progressive jackpots steadily increase as more wagers are placed, displaying progressive jackpots can attract players to the wagering game machines 306. According to some embodiments, the wagering game machines 306 can receive updated jackpot amounts from the cluster controller 308 and present the jackpot amounts on display devices 320, such as a group of flat-panel displays, or a wide-screen television.

In some embodiments, the gaming network 300 includes a player tracking system 324. Player tracking systems 324 can be used to obtain information about player demographics and playing habits. Player tracking systems 324 may use player-tracking devices (e.g., player-tracking devices 244 of FIG. 2) to assist in acquiring player information. As noted above, player-tracking devices can include magnetic cards, flash memory devices, smart cards, RFID modules, or any device, including a portable device, suitable for storing player information.

At the beginning of a gaming session, players may provide player information by inserting player tracking devices into the wagering game machines 306, as described previously. Certain devices, such as RFID modules, may permit reading the information as soon as a player approaches within a selected distance of a gaming machine 306. The player tracking device may provide any type of information, including a player's name, age, gender, address, zip code, account number, prior winnings, etc. During the gaming session, the cluster controller 308 may record the time of day, duration of play, wager amounts, number of games played, and other information about a player's playing habits. Casinos can use the player tracking information to reward players, as well as to market goods and services to specific players.

Player tracking systems 324 may present text messages on auxiliary video displays (e.g., video unit 230 in FIG. 2) that form a part of the wagering game machines 306. The auxiliary displays may comprise character-limited (e.g., twenty character) scrolling text displays or miniature liquid crystal displays (LCDs), as well as more conventional flat-panel or cathode ray tube (CRT) displays. The text messages can include product promotions and other marketing content.

Player tracking systems 324 can also work with casino messaging systems 330 to facilitate delivery of text messages to players at the wagering game machines 306. In particular, casino messaging systems 330 can be used for presenting “harm minimization” or “responsible gaming” messages. Such messages may suggest player rest periods or notify players about amounts wagered or lost. In some gaming jurisdictions, authorities require casino messaging systems 330 to present responsible gaming messages. Casino messaging systems 330 can also present emergency safety messages.

Embodiments of the invention can expand the usefulness of player tracking and casino messaging systems 330. Among other things, certain embodiments allow player tracking systems 324 and casino messaging systems 330 to present multimedia messages, instead of scrolling text messages. Additionally, instead of being limited to small add-on displays (e.g., miniature LCDs, etc.), some embodiments allow player tracking systems 324 and casino messaging systems 330 to present the multi-media messages on the wagering game machines' primary displays, secondary displays, and/or audio presentation units (e.g., elements 210, 212, and 246 of FIG. 2, respectively). Furthermore, some embodiments allow wagering game machines 306 to present responsible gaming messages without any further modification or inspection by gaming authorities.

While the previous discussion has focused on some of the mechanisms that may be used in various embodiments, especially with respect to hardware for gaming machines and gaming networks, the following will provide some additional detail with respect to additional embodiments that can affect the interaction between characters, events, such as gaming outcomes, and three-dimensional visual environments in a wagering game.

Referring now to FIGS. 1, 2, and 3, it can be seen that a wagering game system 200 (which may comprise one or more gaming machines 100, 206, 306, or a gaming network 204, 300) may include one or more player-input devices 108, 208 and one or more processors (e.g., CPU 226) to conduct a wagering game responsive to the player-input devices 108, 208. The processor in the wagering game system 200 may also be used to initiate generating a plurality of three-dimensional particles 150. The wagering game system 200 may include one or more displays 104, 110, 210, 212, 230 on which the three-dimensional particles 150 can be rendered in real time.

The particles 150 can be used to model amorphous objects, including water and smoke. The particles 150 may also be used to define surfaces, smooth or otherwise, including the surfaces of rigid and non-rigid objects. Particles 150 may emanate from one or more emitters 151, and the activity of the particles 150 may be used to determine a gaming outcome (e.g., the number of particles impacting a surface may accumulate to award a win). Accumulations of particles 150 may affect the actions or abilities of characters (e.g., a stream of particles may present an impassable object to a character), or features of the environment (e.g., a landslide of particles may demolish a tree, or simply knock it over).

Thus, instead of a set of primitive surface elements, e.g., polygons or patches, groups or systems of particles 150 may be used to define a volume. A particle system may be a dynamic entity, moving and changing form, within which new particles are created and old particles are destroyed.

Particle systems may take advantage of stochastic procedural modeling, similar to fractals, such that complex systems can be created with relative ease. In addition, the level of detail can be easily adjusted. For example, distant particles 150 can be modeled with low detail (e.g., as a small system of particles), and close particles 150 may be modeled with high detail (e.g., as a large system of particles).

When particles 150 are used to model an object in an animation sequence, one or more of the following actions may be performed for each frame: generate new particles, assign attributes to each new particle, destroy particles that have existed past their assigned lifetime, and transform/move remaining particles according to assigned dynamic attributes. Afterwards, an image of the remaining particles 150 can be rendered (i.e., wherein the image pixels are generated from the high-level description of the image components and displayed), perhaps in real time.

A task may be accomplished in real-time if the combined reaction and operation-time of the task is shorter than the maximum delay that is permitted. In the case of particle display, this means that generation, attribute processing, and rendering should be accomplished for each particle in a system of particles within a frame at the desired frame rate, which may be on the order of fifteen frames-per-second (fps), twenty fps, thirty fps, or even faster.

Stochastic processes may be used to create and change the appearance of an object defined by a system of particles 150. Particles 150 may also be generated using stochastic methods. For example, a designer may control the mean number of particles generated per frame, as well as their variance. Alternatively, the designer may decide to generate a certain number of particles per screen area, making it easier to control the level of detail.

Particle 150 attributes may include: position, velocity (speed and direction), size, color, transparency, shape (e.g., spherical, rectangular, or streaked spherical), and lifetime, among others. A particle system may be distinguished by several parameters that control the initial position of the particles, such as: the particle system origin in space, angles of rotation that provide orientation, and a generation shape (to define the region around the origin in which new particles are placed). The generation shape may also be used to describe the initial direction of new particles, e.g., for a sphere of radius R, the particles might move away from the origin along radii in all directions.

Particles 150 can obscure other particles behind them (e.g., opaque particles). Particles 150 can also be transparent, or translucent, and may cast shadows on other particles. Particles 150 can also interact with other particles or objects, including conventionally modeled primitives. Particle systems may also include a particle hierarchy, comprising particles that are themselves particle systems. Child particle systems can inherit the properties of their parents.

Thus, in some embodiments, a wagering game system 200 may include one or more displays 104, 110, 210, 212, 230 to display a three-dimensional environment 144, 344 associated with a wagering game, wherein the three-dimensional environment 144, 344 includes a plurality of three-dimensional particles 150 responsive to one of an event occurring within the three-dimensional environment 144, 344 (e.g., a ship capsizing in the water), a player selection (e.g., as detected by activation of a player-input device 108, 208), or a game outcome (e.g., a minor jackpot win).

Occlusion culling can enhance the speed of rendering in some embodiments, including those having three-dimensional image scenes and three-dimensional environment displays. It is inefficient to render an object blocked by another in the same scene, needlessly increasing the rendered triangle count, as well as using up resources to apply texture and pixel shading. To increase efficiency, a variety of techniques have been developed to detect these hidden objects and cull them from the rendering process.

Thus, in some embodiments, a wagering game system 200 may include one or more displays 104, 110, 210, 212, 230 to display portions of a three-dimensional environment 144, 344 associated with the wagering game. The displayed portions may be selected so as not to be included in a group of culled portions.

In some embodiments, a variety of paths may be established for characters 132 and other objects 146 (e.g., vehicles or cameras) within a three-dimensional environment 144, 344. Such paths may have defined beginning and ending points in space and/or time, and the course of the path may be defined by a mathematical formula. Such paths may include lines and curves (e.g., spline curves, Bezier curves, etc.). Further embodiments may be realized.

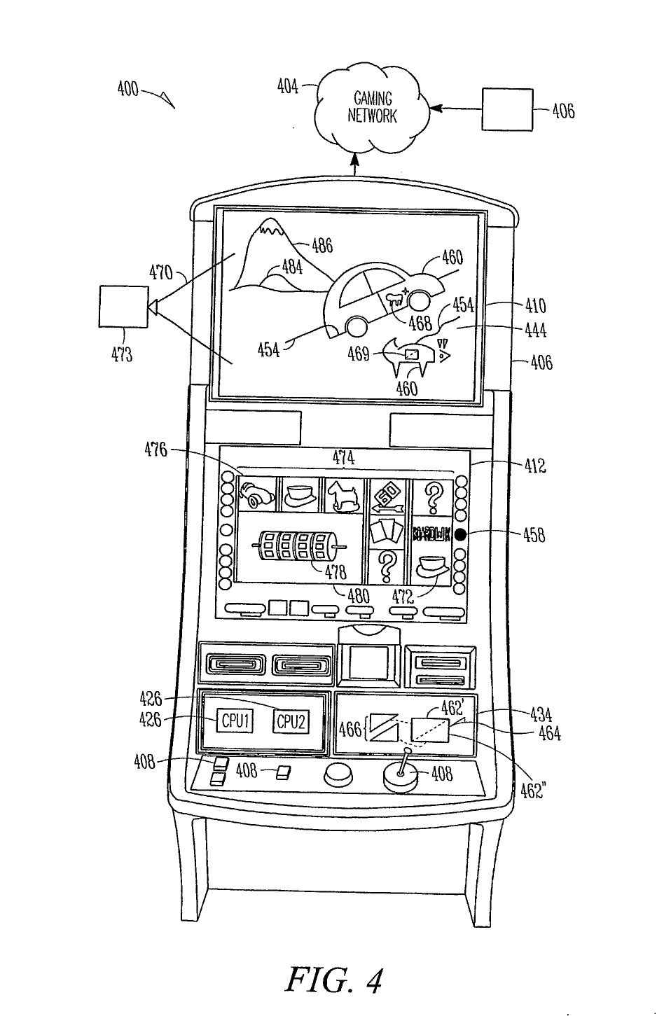

For example, FIG. 4 illustrates a three-dimensional environment 444 in a gaming machine 406 according to various embodiments of the invention. The three-dimensional environment 444 may be similar to or identical to the three-dimensional environments 144, 344 of FIGS. 1 and 3, respectively.

Referring now to FIGS. 1-4, it can be seen that in some embodiments, a wagering game system 400 (which may be similar to or identical to the wagering game system 200 of FIG. 2, including a network 204, 300, 404 of gaming machines 100, 206, 306, 406) may include one or more processors 426 (similar to or identical to CPU 426) to conduct a wagering game 458 responsive to one or more player-input devices 408 (similar to or identical to the player-input devices 108, 208), and to establish a path 454 in a three-dimensional environment 444 associated with the wagering game 458. The wagering game system 400 may include one or more displays 410, 412 (similar to or identical to displays 210, 212 of FIG. 2) to display the three-dimensional environment 144, 344, as well as an object 460 (e.g., a character or camera, among others) following the path 454.

When rendering realistic images, modeling the action of light can be useful in some embodiments, especially with respect to reflection from shiny surfaces, such as mirrors. Using lighting models, shading, reflection, and refraction can be simulated to mimic that which is seen in the real world. The presence, absence, or operation of light within an environment may affect the actions of characters, as well as the gaming outcome (e.g., an extremely bright light may blind a character and prevent a win; or a shadow may hide a winning object).

Local illumination refers to direct interaction between one light source and one object surface. Global illumination refers to the interaction of light between all surfaces in a scene, such as shading, reflection between surfaces, and refraction of surfaces. Global and local illumination can be affected by characters and environments. For example, the sun and clouds may affect the lighting of the earth, and a character with a flashlight, or the headlights of a vehicle, may also affect illumination of the environment

Single object-light interaction may be approximated through local illumination models for rendered graphics. For example, the Phong model, which breaks local illumination into the components of ambient reflection, diffuse reflection, and specular reflection, may be employed. For every point, or small surface area, of an object, the activity of light due to these components may be calculated.

Ambient reflection is a crude approximation to global effects of light, and can be used to account for the general brightness in a scene from light scattering in various directions from various surfaces. Diffuse reflection results from the diffuse, or rough surface properties of many materials. Specular reflection results from the properties of shiny materials that provide highlights from light sources. The highlights observed depend on the viewer's position relative to the surface from which light is reflected. For an ideal mirror, a perfectly reflected ray is symmetric with the incident ray with respect to the normal. However, since most surfaces are not perfectly smooth, there are variations around the ideal reflected ray. In addition, there may be more than one light source reflected off of the same surface.

Ray tracing can be used to cast a ray from the eye (or the camera) through each pixel in the image plane, until the ray intersects an object. Local illumination for this point may be calculated using the Phong model. Intersection points between rays, shadows, and refraction may also be considered as secondary illumination values, as is known to those of skill in the art.

Thus, in some embodiments, a wagering game system 200, 400 may include one or more processors 426 to conduct a wagering game 458 responsive to the player-input device 108, 208, 408. The processors 426 may be used to select a reflective surface 464 in a three-dimensional environment 144, 344, 444 (e.g., associated with a base game event or a bonus event). The wagering game system 200 may also include one or more displays 410, 412 to display an image 468 of an object 460 included in the three-dimensional environment 144, 344, 444 by mapping the image 468 onto the reflective surface 464.

When preparing to render three-dimensional images in some embodiments, various mapping techniques may be used to provide additional flexibility for image manipulation. For example, a rectangular bitmap may be mapped onto the vertices of some triangles so that the image may be more easily rotated and scaled. After rotation, scaling, or other operations are performed, the triangles may be used to display sprites, such as a rectangular sprite.

Thus, in some embodiments, a wagering game system 200, 400 may include one or more processors 226, 426 to map a first portion 462′ and a second portion 462″ of a rectangular bitmap 464 associated with the wagering game 458 onto a pair of triangles 466. The wagering game system 400 may also include one or more displays 410, 412 to display a rectangular sprite 468 using the pair of triangles 466.

Virtual cameras may be used in many embodiments. For example, a player may adopt a camera viewpoint 470 as a part of a wagering game 458 that follows a predetermined path 454, or is fixed to a particular location. Controls may be provided, such as pan and tilt, zoom, focus, f-stop (e.g., depth of field), distance to subject, viewing angle relative to a character or object in the three-dimensional environment, etc. Cameras 473 may also interact with objects 460, such as characters, and the environment 444, such that a camera 473 may be used to record and playback “director's takes” or scene sequences, as requested by a player.

Thus, in some embodiments, a wagering game system 200, 400 may include one or more displays 410, 412 to display a three-dimensional environment 144, 344, 444 associated with the wagering game 458, and a camera viewpoint 470 responsive to an event occurring within the wagering game (e.g., a jackpot win) or an event occurring within the three-dimensional environment (e.g., collision between objects 460, such as characters, or between a character and an object 460 in the three-dimensional environment 144, 344, 444). The camera viewpoint 470 may also be responsive to activation of the player-input device 408.

In some embodiments, windowed environments can be a useful mechanism to manage visual information. For example, separate windows on a display may be used to contain separate three-dimensional environments, or to separate groups of objects, such as characters. In some embodiments, windows may be separated so that a player may view all parts of uncovered windows. In some embodiments, one window may cover a portion of another, including situations where one window is completely included within another (e.g., a picture-in-a-picture display).

Thus, in some embodiments, a wagering game system 400 may include one or more displays 410, 412 to display a first image 472 associated with the gaming outcome 474 within a first window 476 (e.g., displaying a first reel image on a display within the first window), and a second image 478 associated with the gaming outcome 474 within a second window 480 (e.g, displaying a second reel image on the display within a second window).

Events occurring within the wagering game 458, or within the three-dimensional environment 144, 344, 444, or both, can be used to evolve a feature 484 of the three-dimensional environment 144, 344, 444. Thus, evolution of an environmental feature 484 may occur in response to a plurality of sequential events occurring within the wagering game (e.g., two jackpots of increasing value in a single game, among others), or a plurality of sequential events occurring within the three-dimensional environment 144, 344, 444 (e.g., a trickle of water growing from a stream to a flood, or repeated automobile accidents, among others).

Environmental feature 484 evolution may occur in a manner similar to or identical to the evolution of character features in traditional role playing games and other games, such as the game Spore, developed by Maxis Studio and published by Electronic Arts, and known to those of ordinary skill in the art.

For example, a player may begin with a three dimensional environment 444 in some basic form, such as a two bedroom house and, via feature evolution, eventually provide a mansion having hundreds of rooms. Similarly, the environmental feature 484 of a small hill may evolve into the evolved feature 486 of a mountain. Features 484 and evolved features 486 can interact with other features and other evolved features, as well as with characters 132 and objects 460 that may also have evolved within the three-dimensional environment 144, 344, 444.

Environments 144, 344, 444 may be transported or “shared” between gaming systems, perhaps using a network 300 having a variety of gaming machines 306 coupled to it, wherein each gaming machine 306 has its own three-dimensional environment 344, such as a house, a vehicle, a farm, a town, a city, a suburb, a state, a country, a continent, an ocean, a planet, a satellite, or a star system. Transport may take place when one player permits the migration of an environment 344 from one gaming machine 306 to another, perhaps by moving or copying the environment 344 and its associated features (and possibly some of the objects, such as characters, included in the environment) to a second gaming machine 306. Characters 132 can populate, conquer, interact with, or merely observe the environments 144, 344, 444 in which they are located. Environments 344, as well as characters, may be controlled by the local gaming machine 306, another gaming machine 306, or a server 308 that couples one or more gaming machines 306 to a network 300, including a peer-to-peer network.

Environment meshes, textures, animations, feature acquisition, capabilities, and overall behaviors may be regulated by procedures (e.g., based on one or more sets of algorithmic rules), giving rise to virtually unlimited player-created content. The player-created content may be “owned” by an identified player, and perhaps shared among players. Such content, which may exist in the form of content libraries, may include individual characters, buildings, vehicles, entire civilizations, planets, and star systems, as well as other environments. Ownership may also include the degree of mastery over the player interaction interface, which can become more complex as the scale of the environment increases.

Thus, in some embodiments, a wagering game system 200, 400 may include one or more displays 410, 412 to display a three-dimensional environment 144, 344, 444 associated with the wagering game 458. The displays 410, 412 may also be used to display evolved features 486 of the three-dimensional environment 144, 344, 444 responsive to one of a plurality of sequential events occurring within the wagering game 458 or a plurality of sequential events occurring within the three-dimensional environment 144, 344, 444.

Any of the components previously described can be implemented in a number of ways, including software embodiments. Thus, the gaming machine 100, 206, 306; coin slot 102; display units 104, 110; credit display 106; player-input devices 108, 208, 408; bet display 112; bet one button 116; cash out button 118; reels 120; readers/validators 122; bill acceptor 124; audio presentation units 128, 246; auxiliary video display 130; characters 132; enclosure 134; evolved character 136; three-dimensional environments 144, 344, 444; vehicles 146; particles 150; wagering game system 200, 400; article of manufacture 202; gaming network 204; displays 210, 212, 410, 412; I/O bus 222; network interface unit 224; CPU 226; memory unit 228; video unit 230; nonvolatile memory 232; volatile memory 234; money/credit detector 214; touch screen 216; payout mechanism 218; information reader 220; graphics accelerator 240; machine-readable media 242; player-tracking device 244; instructions 291; wagering game network 300; cluster controller 308; wired connections 310; wireless connections 312; display device 320; player tracking system 324; messaging systems 330; processors 426; path 454; wagering game 458; objects 460; reflective surface 464; image 468; bitmap portions 462′, 462″; rectangular bitmap 464; pair of triangles 466; rectangular sprite 468; camera viewpoint 470; cameras 473; images 478; gaming outcome 474; windows 476, 480; environmental feature 484; and evolved feature 486 may all be characterized as “modules” herein.

Such modules may include hardware circuitry, and/or a processor and/or memory circuits, software program modules and objects, and/or firmware, and combinations thereof, as desired by the architect of the gaming machines 100, 206, 306, 406 and as appropriate for particular implementations of various embodiments. For example, in some embodiments, such modules may be included in an apparatus and/or system operation simulation package, such as a software electrical signal simulation package, a power usage and distribution simulation package, a real-time telemetry simulation package, a power/heat dissipation simulation package, and/or a combination of software and hardware used to simulate the operation of various potential embodiments.

It should also be understood that the apparatus and systems of various embodiments can be used in applications other than for wagering gaming systems, and thus, various embodiments are not to be so limited. The illustrations of gaming machines 100, 206, 306, 406 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, and vehicles, among others. Some embodiments include a number of methods.

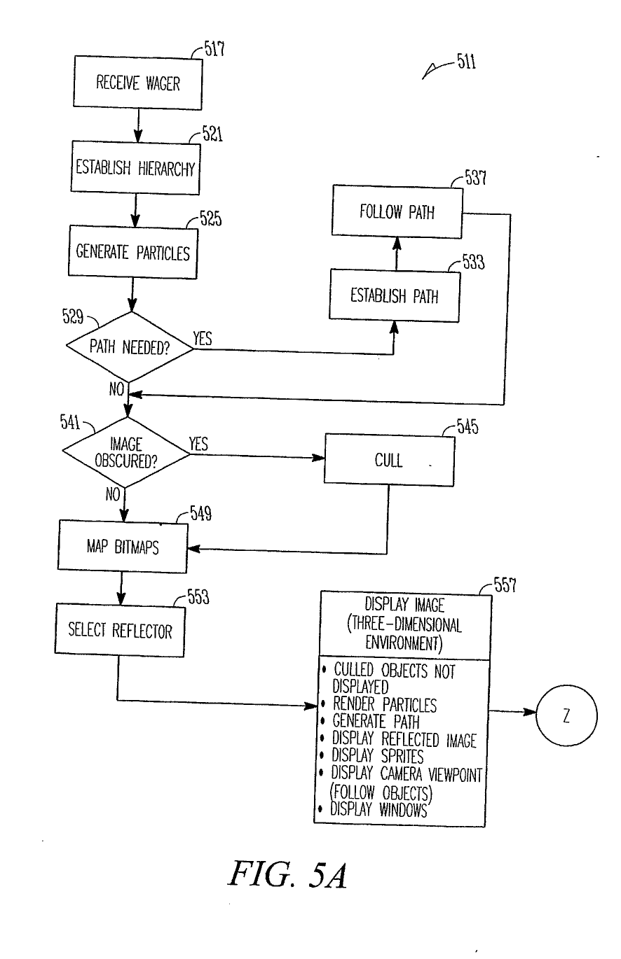

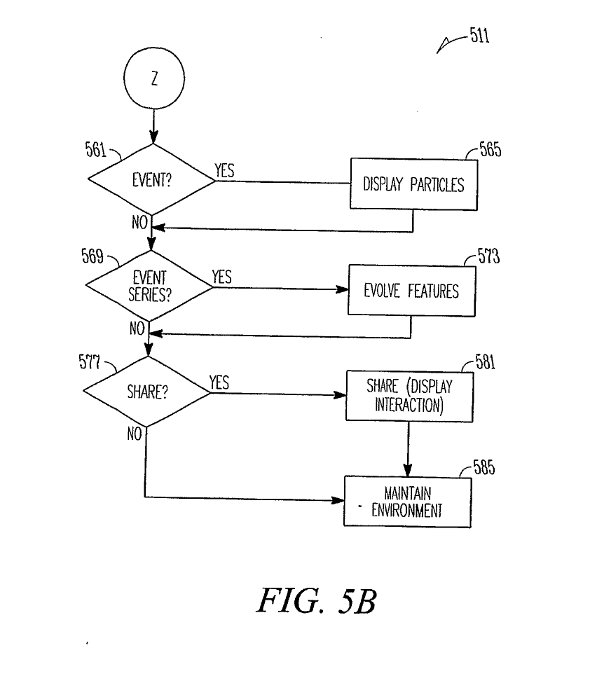

For example, FIGS. 5A-5B include a flow diagram illustrating several methods 511 according to various embodiments of the invention. For example, in a gaming machine that produces a gaming outcome, or receives a gaming outcome, and then displays the gaming outcome on a display, such methods 511 may include a variety of activities, which may occur in the order described below, or shown in the figures, or in any other order. For example, in a machine, such as a reel-based gaming machine, the method may include displaying a gaming outcome of a base game or a bonus game.

In some embodiments, the method 511 may begin at block 517 with receiving a wager to play a wagering game. The method 511 may continue at block 521 with establishing a rendering hierarchy (e.g., perhaps prior to culling objects or characters in the lower levels of the hierarchy before rendering the resulting image on a display). The method 511 may continue at block 525 with generating a plurality of three-dimensional particles. It should be noted that generation (e.g., including the activity of assigning attributes to particles and systems of particles), as well as rendering an image including particles on the display, may occur in real time. One or more of the plurality of particles may be associated with a variety of properties including a color, a position, a velocity, a texture, a viewpoint, a mesh, a rule of motion, a lifetime, or a transparency, among others. Particle motion, generation, and emission may be affected by lighting, paths, characters, and gaming outcomes in an environment. Similarly, lighting, paths, characters, and gaming outcomes in an environment may be influenced or changed by particle motion, generation, and emission.

In some embodiments, one or more paths may be used for directing the movement of objects (e.g., cameras or characters) in a three-dimensional environment. If a path is used for this purpose, as determined at block 529, the method 511 may include establishing a path in a three-dimensional environment associated with the wagering game at block 533. If an object has physical attributes (e.g., the arms and legs of a character, or the wheels of a car, or the sword of a warrior), the method 511 may also include defining a plurality of physical attribute paths followed by the attributes of the object in relation to the defined path at block 533. The particular path generated may affect the gaming outcome (e.g., if a character follows a path into a brick wall, the bonus may be ended). The intersection of paths generated may also affect gaming outcomes (e.g., the bonus is awarded if a character path crosses the path of a pot of gold, and the bonus is forfeit if the character path intersects the path of a monster). The path generated may be affected by the environment and/or the character which is to follow it, or the action of local or global lighting.

The method 511 may include following the path with the object (e.g., a character), including the physical attributes of the object, at block 537. The object, or a group of objects, may follow the path from a designated starting point to a designated ending point, and the designated starting point and the designated ending point may be associated with a selected time period. Thus, as time passes, the object may follow the path as an abstraction in memory, and may or may not be displayed, depending on whether culling is in effect, the frame rate of image generation, etc.

In some embodiments, the method 511 may include determining whether portions of an image to be rendered are obscured at block 541. Such a determination may occur, for example, if some portions (e.g., background portions) of the three-dimensional environment are at least partially obscured by foreground objects. The determination may also occur if one object in the three-dimensional environment is lower in an established rendering hierarchy than another. In any case, culling may occur by taking the partially-obscured (or wholly obscured) portions, and/or objects lower down in the rendering hierarchy, and including them in a group of culled portions at block 545.

As noted previously, bit mapping reflective surface modeling techniques may be used in various embodiments. Thus, in some embodiments, the method 511 may include mapping a first portion and a second portion of a rectangular bitmap associated with the wagering game onto a pair of triangles at block 549. The method 511 may also include selecting a reflective surface in a three-dimensional environment at block 553, perhaps in association with the occurrence of a selected base game event or a bonus event.

In some embodiments, the method 511 may include displaying one or more images at block 557, perhaps including a three-dimensional environment associated with the wagering game. In some embodiments, culling is used to segregate a group of objects that will not be displayed, perhaps by including those objects in a group of culled portions. Thus, the method 511 may include displaying portions of the three-dimensional environment associated with the wagering game that are not included in the group of culled portions.

Many activities may occur at block 557. For example, one or more pluralities of particles (including particle systems) may be rendered on the display. One or more particles may emanate from a single emitter, and the emitter may receive parameters to affect display of the particles. In some cases, emitters may even spawn other emitters. The display of particles may be responsive to an event occurring within the three-dimensional environment, a player selection, or a game outcome (e.g., resulting from the play of reels, cards, dice, or a bonus experience, among others).

Other activities that may occur at block 557 include the generation of one or more paths. The paths may be displayed, if desired. In many instances, objects, such as three-dimensional characters or a camera providing a view of the three-dimensional environment, may be displayed as moving along an invisible generated path, giving an implicit indication of the location of the path in the three-dimensional environment.

Further activities occurring at block 557 may include displaying an image of an object included in the three-dimensional environment by mapping the image onto the reflective surface selected at block 553. This may occur, for example, by reflecting a camera viewpoint ray to intersect a texture map, and displaying a portion of a three-dimensional model based on coordinates of the texture map intersected by the camera viewpoint ray. The coordinates of the texture map may be provided by a spherical mapping technique or a cubic mapping technique, among others.

In some embodiments, the activities at block 557 may include displaying one or more rectangular sprites using the pair of triangles mapped at block 549. This may include, for example, mapping properties onto one or more of the vertices of the pair of triangles, such as a color, a position, a velocity, a texture coordinate, a rule of motion, a lifetime, or a transparency.

In some embodiments, the activities at block 557 may include displaying a camera viewpoint. This may occur, for example, by displaying a camera viewpoint responsive to an event occurring within the wagering game or an event occurring within the three-dimensional environment, or both. The event that occurs may modify some property associated with the camera viewpoint, such as the viewing location, the viewing distance, the viewing angle, the viewing magnification, the focus location, or the depth of field. In some embodiments, the method 511 may include following a selected object included in the three-dimensional environment with the camera viewpoint, and the selected object may be selected in association with the event that occurs. The origin of the camera viewpoint may be fixed, or directed to follow a selected path (e.g., alternating between a pair of talk show hosts to follow the conversation between them). The path may be selected so as to substantially avoid view-obstructing objects.

In some embodiments, the activities that occur at block 557 may include displaying a first image associated with the gaming outcome within a first window (e.g., displaying a first reel image on a display within a first window), and displaying a second image associated with the gaming outcome within a second window (e.g., displaying a second reel image on the display within a second window). In some cases, the first window and the second window may be partially-overlapping. The method 511 may include displaying a three-dimensional environment in some, none, or all of the windows that are displayed. Some of the windows may be configured to display a set of player preferences.

In some embodiments, the method 511 may include determining that some selected event, either within the wagering game, or the three-dimensional environment, or both, have occurred at block 551. If this is the case, the method 511 may include displaying a plurality of particles (including one or more particle systems) responsive to the occurrence of the event at block 565.

In some embodiments, the method 511 may include determining that some series of selected events, either within the wagering game, or the three-dimensional environment, or both, have occurred at block 569. If this is the case, the method 511 may include evolving a feature of the three-dimensional environment to provide an evolved environment responsive to the occurrence of the series of events at block 573.

In some embodiments, the method 511 may include determining whether a player desires to share an environment, or an evolved environment (perhaps created by that player), with another player at block 577. If so, then the method 511 may include sharing the evolved environment created by a first player with a second player at block 581, as well as displaying an interaction between one or more characters created by the first player in the evolved environment, with one or more characters created by a second player. Whether an environment is shared or not, the method 511 may include maintaining an evolved environment across a series of completed gaming sessions, perhaps associated with the wagering game, with a unique identifier (e.g., associated with a player, or an identification number), or both, at block 585.

It should be understood that the operations of the flow diagrams can be performed by embodiments of the invention other than those discussed with reference to the block diagrams, and embodiments discussed with references to the block diagrams can perform operations different than those discussed with reference to the flow diagrams. Additionally, some embodiments may not perform all the operations shown in a flow diagram.

Further, it should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

For example, by referring back to FIG. 2, it can be seen that some embodiments of the invention may include an article 285 according to various embodiments, such as a computer, a memory system, a magnetic or optical disk, some other storage device, and/or any type of electronic device or system. The article 285 may include a processor (e.g., CPU 226) coupled to a machine-accessible medium 242 such as a memory (e.g., removable storage media, as well as any memory including an electrical, optical, or electromagnetic conductor) having associated information 291 (e.g., computer program instructions and/or data), which when accessed and executed by the processor, creates a system for executing the various methods described previously.

For example, executing the instructions stored on the medium 242 may result in a machine (e.g., the gaming machine 206) performing such actions as executing a method including receiving a wager to play a wagering game, generating a plurality of three-dimensional particles, and rendering the plurality of particles on the display in real time.

In some embodiments, executing the instructions stored on the medium 242 may result in a machine (e.g., the gaming machine 206) performing such actions as executing a method including receiving a wager to play a wagering game, displaying a three-dimensional environment associated with the wagering game, and displaying a plurality of three-dimensional particles responsive to an event occurring within the three-dimensional environment, a player selection, or a game outcome.

In some embodiments, executing the instructions stored on the medium 242 may result in a machine (e.g., the gaming machine 206) performing such actions as executing a method including culling portions of a three-dimensional environment associated with the wagering game to provide a group of culled portions, and displaying portions of the three-dimensional environment associated with the wagering game that are not included in the group of culled portions.

In some embodiments, executing the instructions stored on the medium 242 may result in a machine (e.g., the gaming machine 206) performing such actions as executing a method including establishing a path in a three-dimensional environment associated with the wagering game, and following the path with an object, such as a character or a camera.

In some embodiments, executing the instructions stored on the medium 242 may result in a machine (e.g., the gaming machine 206) performing such actions as executing a method including selecting a reflective surface in a three-dimensional environment, and displaying an image of an object included in the three-dimensional environment by mapping the image onto the reflective surface.

In some embodiments, executing the instructions stored on the medium 242 may result in a machine (e.g., the gaming machine 206) performing such actions as executing a method including mapping a first portion and a second portion of a rectangular bitmap associated with the wagering game onto a pair of triangles, and displaying a rectangular sprite using the pair of triangles.

In some embodiments, executing the instructions stored on the medium 242 may result in a machine (e.g., the gaming machine 206) performing such actions as executing a method including displaying a three-dimensional environment associated with the wagering game, and displaying a camera viewpoint responsive to an event occurring within the wagering game or an event occurring within the three-dimensional environment.

In some embodiments, executing the instructions stored on the medium 242 may result in a machine (e.g., the gaming machine 206) performing such actions as executing a method including displaying a first image associated with the gaming outcome within a first window, and displaying a second image associated with the gaming outcome within a second window.

In some embodiments, executing the instructions stored on the medium 242 may result in a machine (e.g., the gaming machine 206) performing such actions as executing a method including receiving a wager to play a wagering game, displaying a three-dimensional environment associated with the wagering game, and evolving a feature of the three-dimensional environment to provide an evolved environment, perhaps responsive to a plurality of sequential events occurring within the wagering game, or a plurality of sequential events occurring within the three-dimensional environment.

Implementing the apparatus, systems, and methods of various embodiments may enhance the interaction between events, such as gaming outcomes, user actions, and three-dimensional visual environments in a wagering game, so as to increase player interest through additional opportunities for player-game interaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Thus, in some instances, well-known circuits, structures and techniques have not been shown in detail so as not to obscure understanding of the various embodiments. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. In a gaming machine that displays a gaming outcome on a display, a method comprising:
receiving a wager to play a wagering game;
generating a plurality of three-dimensional particles; and
rendering the plurality of particles on the display in real time.

2. The method of claim 1, wherein the plurality of particles emanate from a single emitter.

3. The method of claim 1, wherein some of the plurality of particles are associated with properties including at least one of a color, a position, a velocity, a texture, a viewpoint, a mesh, a rule of motion, a lifetime, or a transparency.

4. In a gaming machine that displays a gaming outcome on a display, a method comprising:
receiving a wager to play a wagering game;
displaying a three-dimensional environment associated with the wagering game; and
displaying a first plurality of three-dimensional particles responsive to one of an event occurring within the three-dimensional environment, a player selection, or a game outcome.

5. The method of claim 4, further including:
displaying a second plurality of particles responsive to an event occurring within the wagering game.

6. The method of claim 4, wherein the plurality of particles emanate from a single emitter.

7. The method of claim 4, wherein some of the plurality of particles are associated with properties including at least one of a color, a position, a velocity, a texture, a viewpoint, a mesh, a rule of motion, a lifetime, or a transparency.

8. In a gaming machine that displays a gaming outcome on a display, a method comprising:
culling portions of a three-dimensional environment associated with the wagering game to provide a group of culled portions; and
displaying portions of the three-dimensional environment associated with the wagering game that are not included in the group of culled portions.

9. The method of claim 8, wherein culling includes:
selecting portions of the three-dimensional environment that are at least partially obscured by foreground objects for inclusion in the group of culled portions.

10. The method of claim 8, wherein culling includes:
establishing a rendering hierarchy;
determining that a first object in the three-dimensional environment is lower in the rendering hierarchy than a second object in the three-dimensional environment; and
selecting the first object for inclusion in the group of culled portions.

11. In a gaming machine that displays a gaming outcome on a display, a method comprising:
establishing a path in a three-dimensional environment associated with the wagering game; and
following the path with an object.

12. The method of claim 11, wherein the object comprises a camera to provide a view of the three-dimensional environment.

13. The method of claim 11, wherein the object comprises a three-dimensional character included in the three-dimensional environment.

14. The method of claim 11, wherein a plurality of physical attribute paths followed by attributes of the object are defined in relation to the path.

15. The method of claim 11, wherein the object follows the path from a designated starting point to a designated ending point.

16. The method of claim 15, wherein the designated starting point and the designated ending point are associated with a selected time period.

17. In a gaming machine that displays a gaming outcome on a display, a method comprising:
selecting a reflective surface in a three-dimensional environment; and
displaying an image of an object included in the three-dimensional environment by mapping the image onto the reflective surface.

18. The method of claim 17, further including:
reflecting a camera viewpoint ray to intersect a texture map; and
displaying a portion of a three-dimensional model based on coordinates of the texture map intersected by the camera viewpoint ray.

19. The method of claim 18, wherein coordinates of the texture map are provided by one or a spherical mapping technique or a cubic mapping technique.

20. In a gaming machine that displays a gaming outcome on a display, a method comprising:
mapping a first portion and a second portion of a rectangular bitmap associated with the wagering game onto a pair of triangles; and
displaying a rectangular sprite using the pair of triangles.

21. The method of claim 20, further including:
mapping properties onto some vertices of the pair of triangles.

22. The method of claim 21, wherein the properties include at least one of a color, a position, a velocity, a texture coordinate, a rule of motion, a lifetime, or a transparency.

23. In a gaming machine that displays a gaming outcome on a display, a method comprising:
displaying a three-dimensional environment associated with the wagering game; and
displaying a camera viewpoint responsive to one of an event occurring within the wagering game or an event occurring within the three-dimensional environment.

24. The method of claim 23, wherein the event modifies at least one of a viewing location, a viewing distance, a viewing angle, a viewing magnification, a focus location, or a depth of field associated with the camera viewpoint.

25. The method of claim 25, further including:
following a selected object included in the three-dimensional environment with the camera viewpoint.

26. The method of claim 25, wherein the selected object is selected in association with the event.

27. The method of claim 23, wherein an origin of the camera viewpoint is fixed.

28. The method of claim 23, wherein an origin of the camera viewpoint follows a selected path.

29. The method of claim 28, wherein the selected path is selected to substantially avoid view-obstructing objects.

30. In a gaming machine that displays a gaming outcome on a display, a method comprising:
displaying a first image associated with the gaming outcome within a first window; and
displaying a second image associated with the gaming outcome within a second window.

31. The method of claim 30, wherein the first window and the second window are partially-overlapping.

32. The method of claim 30, further including:
displaying a three-dimensional environment in the second window on the display.

33. The method of claim 30, further including:
configuring one of the first window and the second window to display a set of player preferences.

34. In a gaming machine that displays a gaming outcome on a display, a method comprising:
receiving a wager to play a wagering game;
displaying a three-dimensional environment associated with the wagering game; and
evolving a feature of the three-dimensional environment to provide an evolved environment responsive to one of a plurality of sequential events occurring within the wagering game or a plurality of sequential events occurring within the three-dimensional environment.

35. The method of claim 34, further including:
sharing the evolved environment created by a first player with a second player.

36. The method of claim 34, further including:
displaying an interaction between at least one character created by a first player in the evolved environment and a second character created by a second player.

37. The method of claim 34, further including:
maintaining the evolved environment across a series of completed gaming sessions associated with the wagering game and a unique identifier.

38. A wagering game system, comprising:
a player-input device;
a processor to conduct the wagering game responsive to the player-input device and to initiate generating a plurality of three-dimensional particles; and
a display to render the plurality of three-dimensional particles in real time.

39. A wagering game system, comprising:
a player-input device;
a processor to conduct the wagering game responsive to the player-input device; and
a display to display a three-dimensional environment associated with the wagering game, wherein the three-dimensional environment includes a plurality of three-dimensional particles responsive to one of an event occurring within the three-dimensional environment, a player selection, or a game outcome.

40. A wagering game system, comprising:
a player-input device;
a processor to conduct the wagering game responsive to the player-input device; and
a display to display portions of a three-dimensional environment associated with the wagering game that are not included in a group of culled portions.

41. A wagering game system, comprising:
a player-input device;
a processor to conduct the wagering game responsive to the player-input device, and to establish a path in a three-dimensional environment associated with the wagering game; and
a display to display the three-dimensional environment and an object following the path.

42. A wagering game system, comprising:
a player-input device;
a processor to conduct the wagering game responsive to the player-input device, and to select a reflective surface in a three-dimensional environment [e.g., associated with a base game event or a bonus event]; and
a display to display an image of an object included in the three-dimensional environment by mapping the image onto the reflective surface.

43. A wagering game system, comprising:
a player-input device;
a processor to conduct the wagering game responsive to the player-input device, and to map a first portion and a second portion of a rectangular bitmap associated with the wagering game onto a pair of triangles; and
a display to display a rectangular sprite using the pair of triangles.

44. A wagering game system, comprising:
a player-input device;
a processor to conduct the wagering game responsive to the player-input device; and
a display to display a three-dimensional environment associated with the wagering game, and a camera viewpoint responsive to one of an event occurring within the wagering game or an event occurring within the three-dimensional environment.

45. A wagering game system, comprising:
a player-input device;
a processor to conduct the wagering game responsive to the player-input device; and
a display to display a first image associated with the gaming outcome within a first window, and a second image associated with the gaming outcome within a second window.

46. A wagering game system, comprising:
a player-input device;
a processor to conduct the wagering game responsive to the player-input device; and
a display to display a three-dimensional environment associated with the wagering game, and an evolved feature of the three-dimensional environment responsive to one of a plurality of sequential events occurring within the wagering game or a plurality of sequential events occurring within the three-dimensional environment.

47. An article comprising a machine readable medium having instructions stored thereon, wherein the instructions, when executed by a processor, create a system for executing the method of claim 1.

48. An article comprising a machine readable medium having instructions stored thereon, wherein the instructions, when executed by a processor, create a system for executing the method of claim 4.

49. An article comprising a machine readable medium having instructions stored thereon, wherein the instructions, when executed by a processor, create a system for executing the method of claim 8.

50. An article comprising a machine readable medium having instructions stored thereon, wherein the instructions, when executed by a processor, create a system for executing the method of claim 11.

51. An article comprising a machine readable medium having instructions stored thereon, wherein the instructions, when executed by a processor, create a system for executing the method of claim 17.

52. An article comprising a machine readable medium having instructions stored thereon, wherein the instructions, when executed by a processor, create a system for executing the method of claim 20.

53. An article comprising a machine readable medium having instructions stored thereon, wherein the instructions, when executed by a processor, create a system for executing the method of claim 23.

54. An article comprising a machine readable medium having instructions stored thereon, wherein the instructions, when executed by a processor, create a system for executing the method of claim 30.

55. An article comprising a machine readable medium having instructions stored thereon, wherein the instructions, when executed by a processor, create a system for executing the method of claim 34.
